(19) United States
(12) Patent Application Publication
(10) Pub. No.: US 2025/0326105 A1
(43) Pub. Date: Oct. 23, 2025

(54) Ultimate Workhorse

(71) Applicants: Mailelani Cox, Lihue, HI (US); Randal Miyashiro, Kapaa, HI (US)

(72) Inventors: Mailelani Cox, Lihue, HI (US); Randal Miyashiro, Kapaa, HI (US)

(21) Appl. No.: 18/638,188

(22) Filed: Apr. 17, 2024

(51) Int. Cl. B25H 1/06

(52) U.S. Cl. CPC B25H 1/06

(57) ABSTRACT

The present invention is an individual sawhorse leg support unit with unlimited options to greatly increase vertical strength, lateral strength, rigidity, and length for a sawhorse/work stand. With the option of incorporating additional leg support units onto disposable cross braces, the limitations on workspace strength and size are eliminated and limitless.

### FIELD OF THE INVENTION

The present invention relates generally to a strong, industrial strength sawhorse apparatus, in particular the leg supports of the apparatus which provide an extremely rigid structure.

### BACKGROUND OF THE INVENTION

There are many known devices for construction sawhorses and work stands. Depending on its intended use, sawhorses and work stands range in strength, weight, stability, and portability. One example is the folding plastic sawhorse, which is traditionally lightweight, and easy to set up, transport, and store. Another example is the heavy-duty folding metal work stand which provides a heavier duty application yet has a compact design to allow for easy transport and storage. While both are indispensable in the construction industry, each has its limitations in terms of strength, rigidity, and overall reliability over time. It is important a sawhorse is conveniently lightweight, easy to set up, and portable, yet robust enough to withstand the weight of heavier tools and work pieces. This invention addresses the aforementioned limitations, and more specifically, the invention comprises a sawhorse apparatus which optionally replaces the conventional four-legged sawhorse.

### SUMMARY OF THE INVENTION

The present invention is comprised of an individual leg support unit of a sawhorse, and should be configured, at minimum, to work in conjunction with additional leg support units with the primary focus on the end user choosing their preferred strength and length for their sawhorse and/or work stand. While the invention provides only the leg support for a sawhorse/work stand, essentially, it is this leg support that forms the sawhorse. It also allows the user to choose their choice of disposable lumber as a cross brace and worktop, both of which are not included with the present invention, to form the length and width of their work area. When the invention is configured using additional leg supports and disposable cross braces, the limitations to the system's lateral and vertical strength increases, eliminating restrictions to the size, rigidity, and strength of the desired work area.

In the preferred embodiment, all metal pieces are coalesced such that weldments are straight and uniform without any spatter or cracks. This invention may be embodied in different forms and should not be construed as limited to the embodiments set forth herein; rather, these embodiments are provided by way of illustration only and so that this disclosure will be thorough, complete and will fully convey the full scope of the invention to those skilled in the art.

It is to be understood that both the foregoing general description of the following detailed description provide embodiments of the invention and are intended to provide an overview or framework of understanding the nature and character of the invention as it is claimed.

### BRIEF DESCRIPTION OF THE DRAWINGS

FIG. 1 is a top view of a fully assembled sawhorse apparatus with a disposable cross brace in place and with the present invention incorporating an additional unit.

FIG. 2a is a side elevational view of the present invention as assembled in FIG. 1.

FIG. 2b is a side elevational view of the present invention when using additional units and disposable cross braces.

FIG. 3 is an end elevational view of the present invention.

### DETAILED DESCRIPTION

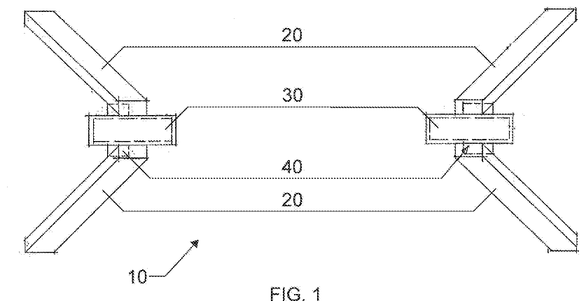

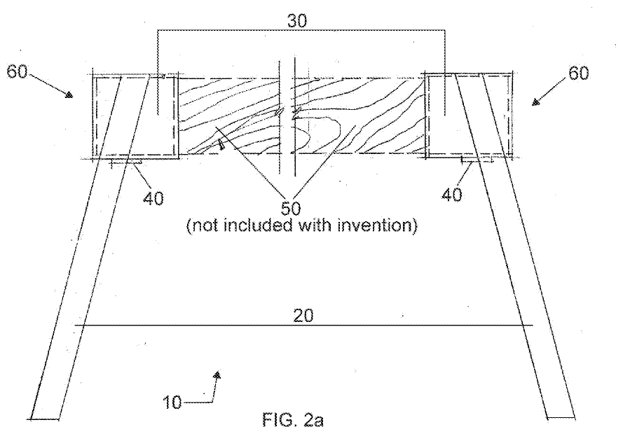

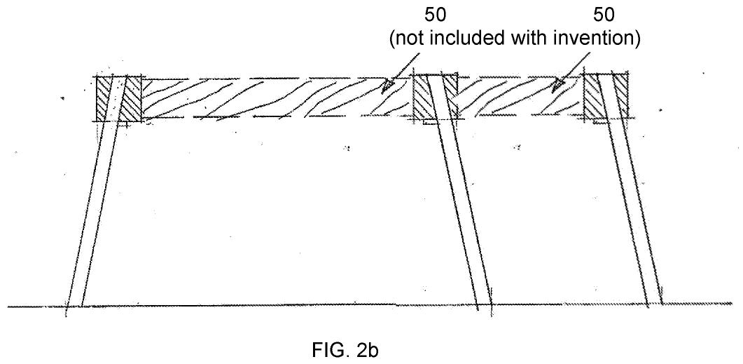

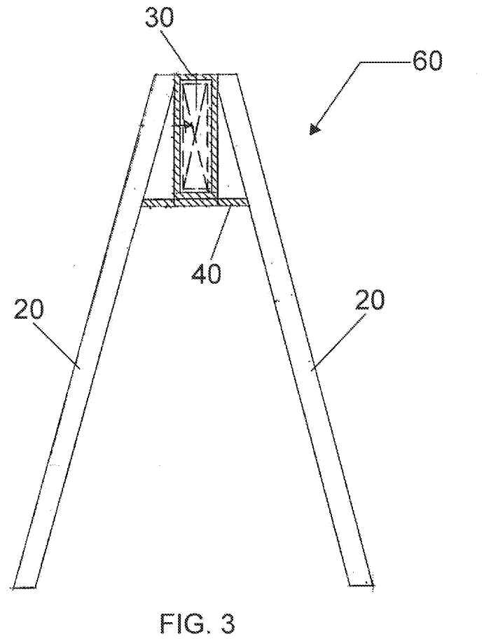

In the following detailed description, the present invention, when assembled using at minimum (2) individual units, will be described in FIG. 1 and FIG. 2, and as an individual unit in FIG. 3.

FIG. 1 shows a top view of the present invention when assembled using, at minimum, (2) units. In FIG. 1, sawhorse/work bench system 10 comprises identical rectangular tubing leg supports 20, a rectangular tube top brace 30, and a bottom flat brace plate 40.

A side elevational view of the present invention is illustrated in FIG. 2a when it is fully assembled using an additional leg support unit 60. The top and bottom ends of each rectangular tubing leg 20 is cut at a precise angle to form a flush top surface when it is attached to the corresponding top side edges of the rectangular tube brace 30, and to generate vertical and lateral stability on the bottom as shown in FIG. 2a. When the present invention is fully assembled using, at minimum, (2) leg support units 60, disposable cross brace 50 shall be inserted into the rectangular tube brace 30 to form a continuous top rail as shown in FIG. 2a. As illustrated in FIG. 2a, the rectangular brace plate 40 provides the leg support unit 60 structure and strength.

When an additional (2) individual leg support units 60 of the present invention as shown in FIG. 2a are used in parallel with a disposable cross brace and worktop, a work stand is formed.

As shown in FIG. 2b, depending on the length of the disposable cross brace 50, optional sawhorse/work bench strengths and lengths could be achieved. One option is to form an oversized, continuous, strong, and rigid sawhorse. For example, should a 20′ disposable cross brace 50 be used, this option allows for the use of additional leg support units 60 as shown in FIG. 3 of the present invention spaced at 5′ to 10′ intervals by sliding each leg support unit 60 onto the disposable cross brace 50 and into place at chosen intervals as shown in FIG. 2b.

Another option could be to use various lengths of disposable cross braces 50. When this option is chosen, the end of each disposable cross brace 50 shall be placed halfway within the rectangular tube brace 30 of each subsequent leg support unit 60 following the initial start unit 60. This option could go on continuously until the desired sawhorse/work bench length is achieved and shown in FIG. 2b.

A third option could be to use both various lengths of disposable cross brace(s) 50 in conjunction with continuous lengths of disposable cross brace(s) 50 by using either the sliding method of leg support unit(s) 60 through the rectangular tube brace(s) 30, or the half sharing method of the rectangular tube brace(s) 30 as shown in FIG. 2b.

FIG. 3 illustrates an end elevational view of the present invention. A fully assembled individual leg support unit 60 incorporates a flat brace plate 40 which is attached to the underside of the rectangular tube brace 30 and rectangular tube legs 20 as shown in FIG. 3.

What is claimed is:

1. A strong, rigid, sawhorse leg support apparatus comprising:
a pair of opposing rectangular tube legs;
a rectangular tube brace; and
a rectangular brace plate.

2. A sawhorse leg support apparatus as in claim 1, wherein said pair of opposing legs are secured to opposing top sides of said rectangular tube brace, wherein said rectangular brace plate is secured to the underside of said rectangular tube brace and said opposing legs at its meeting points.
